(19) United States
(12) Patent Application Publication
(10) Pub. No.: US 2013/0099473 A1
(43) Pub. Date: Apr. 25, 2013

(54) SECURITY ARTICLES COMPRISING SECURITY FEATURES AND METHODS OF MANUFACTURE THEREOF

(71) Applicants: Robert William Harrison, Woking (GB); Matthew Charles Sugdon, Bridlington (GB)

(72) Inventors: Robert William Harrison, Woking (GB); Matthew Charles Sugdon, Bridlington (GB)

(73) Assignee: DE LA RUE INTERNATIONAL LIMITED, Viables, Basingstoke (GB)

(21) Appl. No.: 13/639,708

(22) PCT Filed: Apr. 7, 2011
(86) PCT No.: PCT/GB2011/050692

§ 371 Date: Dec. 17, 2012

(30) Foreign Application Priority Data
Apr. 8, 2010 (GB) 1005895.6

(51) Int. Cl. B42D 15/00

(52) U.S. Cl. CPC B42D 15/00
USPC 283/85

(57) ABSTRACT

A method is disclosed for manufacturing a security feature on a security article. The security article includes a first layer of plastics material, and the method includes, in any order: using a laser to irradiate a first region of the security article, the laser being operated at a low power level and low speed; and using a laser to irradiate a second region of the security article, the second region at least partially overlapping the first, the laser being operated at a higher power level and higher speed. In this way, the overlapping portions of the regions are marked and exhibit an optically variable appearance. Also disclosed is a security article including a first layer of plastics material exhibiting a laser marking of which at least a portion has an optically variable appearance.

This invention relates to security articles, including security documents such as identification cards, passports, driving licences, credit cards, currency and the like, as well as security elements such as patches and threads which may be applied to such documents or to other objects. Particularly, the invention relates to security articles provided with security features, and methods for manufacturing the security features on the articles.

Laser inscription is known in the field of security articles as a means of applying data or graphics to a material in a manner which is very difficult to reverse or change. Unlike conventional printing, in which an ink is laid down on the surface of material, laser inscription involves the material itself being modified by laser irradiation in a visually noticeable manner. The marking can also be tactile. Since it is very difficult to alter this after manufacture, the laser marking thus acts as a security feature in addition to its primary function of visually conveying data or graphics.

Examples of security articles suitable for laser marking are described in our International Patent Application No. PCT/GB2009/001142. Typically, such articles will include at least one layer which is highly absorbent to particular wavelengths of radiation, and the marking will be carried out using, for example, a Nd:YAG laser operating at a corresponding wavelength. The laser-absorbent material absorbs the radiation, usually leading to a change in colour, most often a darkening of the material. The resulting marking is typically black or grey in appearance. The security article may also include additional layers either side of the laser absorbent material, which are largely transparent to the laser radiation and are therefore not marked by the laser.

Whilst such laser inscriptions help to ensure the integrity of the article, preventing fraudulent alteration, the black or grey colouration can lack visual impact when compared with printed features. Further, the visual aspects of the laser inscription can be reproduced to a significant extent by photocopying, for instance.

The present invention provides a method of manufacturing a security feature on a security article, the security article comprising a first layer of plastics material, the method comprising, in any order: using a laser to irradiate a first region of the security article, the laser being operated at a low power level and low marking speed; and using a laser to irradiate a second region of the security article, the second region at least partially overlapping the first, the laser being operated at a higher power level and higher marking speed; whereby the overlapping portions of the regions are marked and exhibit an optically variable appearance.

By carrying out a two-step laser inscription process in this way, the present inventors have found that the resulting marking possesses an optically variable appearance: that is, its appearance (e.g. colour and/or brightness) differs depending on the angle of view, at least over a range of viewing angles. It should be noted that the optically variable effect is apparent from an inspection of the laser marking alone: no additional components or equipment are required in order to perceive the effect. The optically variable effect not only heightens the visual impact of the article itself but also ensures that the visual aspects of the marking cannot be straightforwardly reproduced by copying. The security of the article is thus significantly improved.

The two laser inscription steps can be carried out in either order: what is important is that in one pass, the laser power level (i.e. radiation intensity) will be relatively low as will the speed of beam movement across the article (i.e. low marking speed, analogously, a long dwell time), whereas in the other pass, the laser power level will be high and the beam moved quickly (i.e. short dwell time), relative to the low power, low speed pass. In preferred implementations, the high power, fast laser inscription step will be carried out using similar operating conditions to those of conventional laser marking processes, i.e. suitable for marking a layer of highly absorbent material. For example, in the high power, fast irradiation step, the laser power is preferably sufficiently high that a conventional laser markable material (such as the adhesive layer containing laser absorbent additives described in our International Patent Application No. PCT/GB2009/001142) would be blackened if irradiated by the laser at a marking dwell time of around 0.05 seconds per square mm.

The two passes can be carried out using different lasers and at different radiation wavelengths, but preferably the same laser (or an identical laser) will be used for both steps, and hence the same wavelength of radiation is used in both steps.

Preferably, the step of laser irradiating at a low power level and low speed is performed before the step of laser irradiating at a higher power level and higher speed. Without being bound to theory, it is believed that the optically variable nature of the marking is brought about by the two laser irradiation steps combining to result in a foam-like structure within the plastics material. The foam-like structure has a different appearance at different angles of view.

A further advantage provided by the two-step method is that the plastics material need not be significantly absorbent to the laser irradiation. The present inventors have found that even materials conventionally considered to be substantially transparent to common laser wavelengths, such as PET, can be marked with this technique. Indeed, it is preferred that the first layer of plastics material is formed of a material with low absorbency to the wavelength of the laser so as to avoid the material overheating. It is believed that the low power, slow speed laser irradiation step allows the material to absorb a small degree of radiation, causing a small amount of blackening which increases the material's tendency to absorb radiation. In the high power, faster pass, the material then absorbs significantly, leading to the observed foam-like structure and optically variable appearance.

The difference between the laser powers and speeds in the two passes should be substantive such that significantly different operating conditions are experienced by the article during each step. In preferred implementations, the higher power level is between 1.5 and 4 times higher than the low power level, preferably between 2 and 3 times higher. For example, where the same laser type is used to perform both steps, in the low power step the laser may be operated at between 30% and 40% of its maximum power, whereas in the high power step it may be operated at 70% to 90% of its maximum power. In a particularly preferred example, the laser may be operated at around 40% of its maximum power in the low power step, and at around 80% of its maximum power in the high power step.

Likewise, the higher marking speed is preferably 2 to 20 times the marking speed in the low power pass, more preferably between 5 and 10 times faster. For example, in the high speed pass, the laser may be operated at a marking speed of between 2 and 30 square mm per second, preferably between 15 and 25 square mm per second, still preferably around 18 square mm per second (i.e. a marking time of around 0.05 seconds per square mm). In the slow pass, the speed may be between 0.5 and 5 square mm per second, preferably between 2 to 3 square mm per second, still preferably around 2.5 square mm per second (i.e. a marking time of around 0.4 seconds per square mm).

Any suitable type(s) of laser could be used to perform the irradiation steps. In preferred examples, the laser radiation has a wavelength in the range 240 nm to 11000 nm. Particularly preferred wavelengths are around 532 nm, generated by a DPSS (diode pulsed solid state) laser, 1064 nm, generated by a Nd:YAG laser and 10600 nm, generated by a CO₂ laser. It will be appreciated that, where the “absorbency” (or “transparency”) of the plastics material is discussed in this disclosure, it is the absorbency (or transparency) of that material to the laser wavelength in use that is meant.

As already mentioned, the optically variable marking varies in appearance when viewed at different angles. The marking does not need to be viewed using any special equipment or through any particular components in order to give rise to the effect: it is apparent from the laser marking alone. Preferably, the optically variable marked overlapping portions have a reflective appearance, appearing bright at some viewing angles and relatively dark at others. In particularly preferred examples, the optically variable marked overlapping portions have a metallic appearance, advantageously appearing silver although other metallic colours may also be achievable depending on the starting colour of the plastics material—e.g. a orange-tinted layer may result in a bronze or gold effect in the marking.

The overlapping, optically variable portions may be the only marked (i.e. visible) parts of the security feature—for example, if the two regions entirely and completely overlap one another (i.e. the two laser passes each irradiate precisely the same region of the article, and only that region), then the marking will consist solely of the optically variable portions. However, the first and second regions need not be entirely coincident with one another and in this case the non-overlapping parts of each region may either be marked or left unmarked by the respective laser inscription step, depending on the make-up of the article and on the laser operating parameters. For instance, if the article does not comprise any layers of higher laser absorbency, then non-overlapping parts of the first region may appear as slightly darkened, whereas non-overlapping parts of the second region will tend not to be marked. If, as described below, the article includes additional layers of laser absorbent materials, the non-overlapping of either or both regions may be marked. However, in all cases, the non-overlapping portions will be optically invariable—for instance, they will typically appear uniformly grey or black.

In particularly preferred embodiments, the first or second region is configured to cover a continuous area so as to provide a background of uniform appearance for at least part of the overlapping portions. This is particularly useful where the article is patterned since the background causes the overlapping portions to stand out and increases the overall visual impact. In addition, the background provides a plain and unchanging area against which to compare the appearance of the overlapping portions as it varies at different viewing angles.

The regions can be designed to take any desirable shape or pattern. Preferably, any of the first region, second region or the overlapping portions are configured to take the form of indicia, preferably alphanumerical text, symbols or graphics. In this way, the security feature can be used to convey data. The feature is particularly well adapted for the provision of personalisation information, i.e. data which is unique to one security article such as the owner's name or the document's serial number, since a laser can readily be programmed to inscribe any desired information, and to apply different information to each article.

As already mentioned, the plastics material preferably has a low absorbency to the laser wavelength irradiated. In addition, the plastics material is preferably substantially visually transparent. This is useful since in many implementations, the layer will be an outer layer of a multi-laminate article, and the transparency of the layer enables printing and other features located inboard of the layer to remain visible. Preferably, the first layer of plastics material is sufficiently transparent to the laser radiation such that (with the material in its unmodified state) irradiation at the higher power and higher speed will not substantially mark the plastics material.

As alluded to above, the security article can consist solely of the first layer of plastics material, or this can be the only layer modified by the laser in the security article. However, it has been found that the provision of additional layers can lead to the formation of further enhanced visual effects. Therefore in particularly preferred embodiments, the security article further comprises a second layer of plastics material arranged behind the first and being more highly absorbent to the laser radiation, whereby in the overlapping portions, the second layer of plastics material becomes darkened and exhibits a shadow effect behind the optically variable appearance visible at at least some angles of viewing. For instance, this second layer of plastics material can be akin to those found in conventional laser-marked security articles. The laser marking in this layer appears as a shadow behind the optically variable portions, giving those portions the appearance of a three-dimensional depth. Since the shadow is physically spaced from the optically variable part, being located in an underneath layer, its visibility varies depending on the angle of view. The shadow is typically more apparent when the feature is viewed at an acute angle, and may not be visible at all when the feature is viewed on-axis.

In particularly preferred embodiments, the shadow effect is such that, at an acute viewing angle, the darkened portions of the second layer of plastics material dominate the appearance of the security feature, causing it to appear dark and optically invariable, and at less acute viewing angles, the optically variable appearance of the security feature is visible. Thus the marking is seen to “flip” between having a dark, optically unchanging appearance at acute viewing angles, and the optically variable appearance previously described as the article is tilted.

To ensure the robustness of the article, the security article preferably further comprises a substrate and at least one adhesive layer arranged between the substrate and the first layer of plastics material. Advantageously, at least one of the at least one adhesive layers contains a laser-absorbent additive and constitutes the second layer of plastics material mentioned above. In particularly preferred implementations, the at least one adhesive layer comprises a first adhesive layer adjacent the substrate and containing the laser-absorbent additive, and a second adhesive layer adjacent the first layer of plastics material without any laser-absorbent additive, a print layer being disposed between the first and second adhesive layers. The advantages of placing a print layer between adhesive layers are discussed in PCT/GB2009/001142.

The present invention further provides a security article comprising a first layer of plastics material exhibiting a laser marking of which at least a portion has an optically variable appearance. It will be apparent that a “laser marking” is a modification of the plastics material formed by laser irradiation. As already explained, by “optically variable appearance” it is meant that the appearance of the portion varies depending on the viewing angle. It should be noted that it is a portion of the laser-marked area itself which exhibits the optically variable effect, and not, for instance, its surroundings in the security article (although its surroundings could be configured to present an additional optically variable effect if so desired). The effect is apparent from inspection of the laser marking alone. By providing a laser marking with an optically variable appearance, the security of the article is significantly enhanced for all the reasons discussed above.

In particularly preferred embodiments, the optically variable portion of the laser marking has a reflective appearance, appearing bright at some viewing angles and relatively dark at others. Advantageously the optically variable portion of the laser marking has a metallic appearance, preferably appearing silver.

The entirety of the laser marking could be optically variable. However, preferably, the laser marking further comprises at least one optically invariable region, which preferably appears (uniformly) grey or black. Advantageously, the optically invariable region is configured to provide a uniform background to at least part of the optically variable portion or vice versa. Preferably, the laser marking is configured to define indicia, preferably alphanumeric text, symbols or graphics. The indicia could be formed by the optically variable portion or the optically invariable portion(s) or any combination thereof.

The security article can preferably be provided with a second layer of plastics material to give a shadow effect and/or a substrate and adhesive layers as already discussed. It is preferred that the first layer of plastics material constitutes the outermost layer of the security article (on the surface of the article to be irradiated), although this may not be necessary if any outboard layers are sufficiently transparent to the laser radiation (and allow for viewing of the security feature). Preferably, the first layer of plastics material comprises any of: polyethylene terephthalate (PET), polycarbonate (PC), nylon, poly vinyl chloride (PVC) acrylic, ABS, polyethylene, polypropylene, any combination of these materials, or other plastics suitable for protection of the article as will be known in the art. In preferred examples, the first layer of plastics material has a thickness between 25 and 400 microns, more preferably 50 to 350 microns, most preferably 50 to 100 microns. Advantageously, the substrate comprises any of: a plastics material, preferably a porous plastics material, more preferably a silica filled polyolefin (such as Teslin™, which is a mixture of polyproylene and polyethylene with silica, typically including up to 70% air by volume), or a cellular material, preferably paper or cardboard, or any combination thereof. Preferably, the at least one adhesive layer comprises a heat sealing adhesive, preferably polyethylene/ethylene vinyl acetate (PE/EVA), acrylic or polyurethane systems. Advantageously, the laser absorbent additive comprises a pigment, preferably antimony oxide.

The security article can be manufactured using any suitable technique, but preferably the laser marking is formed using the two-step laser inscription method described above.

Advantageously, the security article is a security document, preferably an ID card, passport, or driving licence, or a credit or debit card, or currency. In other preferred embodiments, the article is a security element, such as an insert, label, transfer, thread or patch.

The security element could ultimately be arranged either wholly on the surface of a document, as in the case of a stripe or patch, or may be visible only partly on the surface of the document in the form of a windowed security thread.

Security threads are now present in many of the world's currencies as well as vouchers, passports, travellers' cheques and other documents. In many cases the thread is provided in a partially embedded or windowed fashion where the thread appears to weave in and out of the paper. One method for producing paper with so-called windowed threads can be found in EP0059056. EP0860298 and WO03095188 describe different approaches for the embedding of wider partially exposed threads into a paper substrate, any of which are suitable for incorporating the security article into a document. Wide threads, typically with a width of 2 to 6 mm, are particularly useful as the additional exposed area allows for better use of overt security features such as those provided by the present invention.

The security element could be incorporated into a document such that regions of the element are viewable from both sides of the document. Techniques are known in the art for forming transparent regions in both paper and polymer substrates. For example, WO8300659 describes a polymer banknote formed from a transparent substrate comprising an opacifying coating on both sides of the substrate. The opacifying coating is omitted in localised regions on both sides of the substrate to form a transparent region.

Methods for incorporating a security device such that it is viewable from both sides of a paper document are described in EP1141480 and WO03054297. In the method described in EP1141480, one side of the device is wholly exposed at one surface of the document in which it is partially embedded, and partially exposed in windows at the other surface of the substrate.

In the case of a stripe or patch, the security element is preferably prefabricated on a carrier substrate and transferred to the substrate in a subsequent working step.

Examples of methods of manufacturing security features, and security articles bearing such features will now be described with reference to the accompanying drawings, in which:

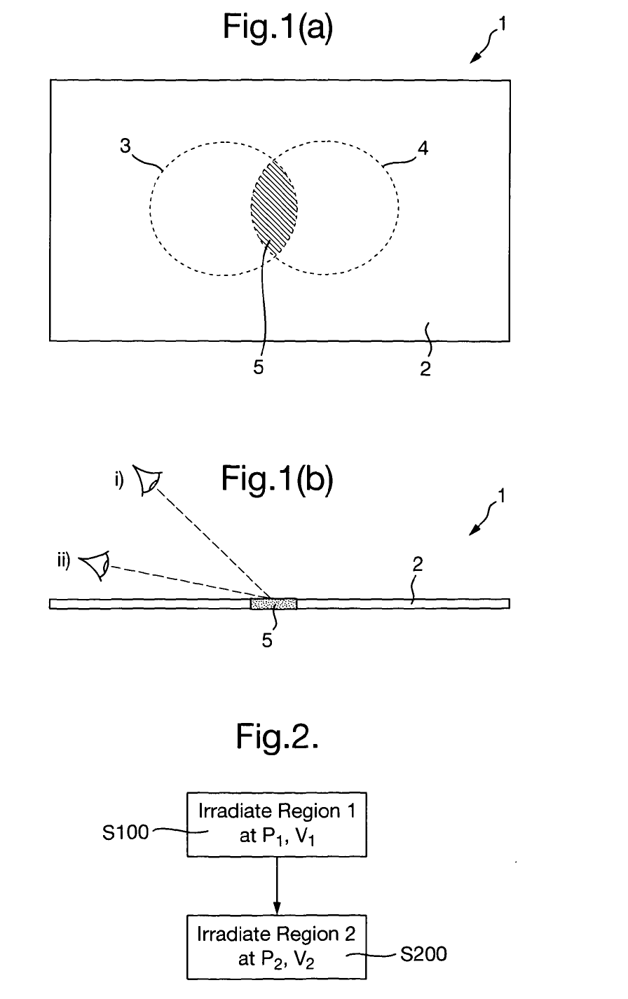

FIG. 1(a) shows a plan view of a first embodiment of a security article;

FIG. 1(b) shows a cross-section through the security article of FIG. 1(a);

FIG. 2 shows steps involved in an exemplary method of manufacturing a security feature on a security article;

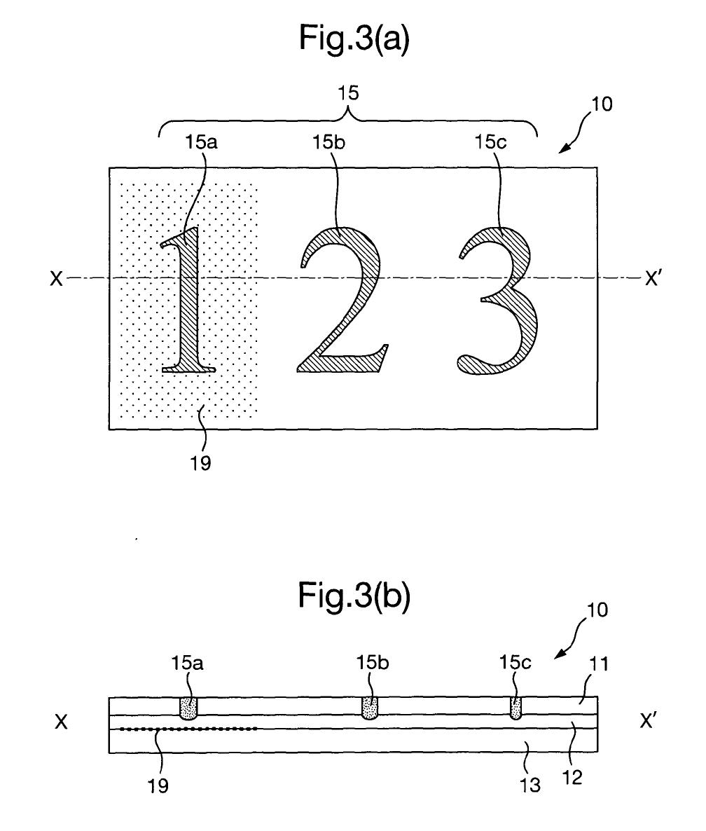

FIG. 3(a) shows a plan view of a second embodiment of a security article;

FIG. 3(b) shows a cross-section through the security article of FIG. 3(a);

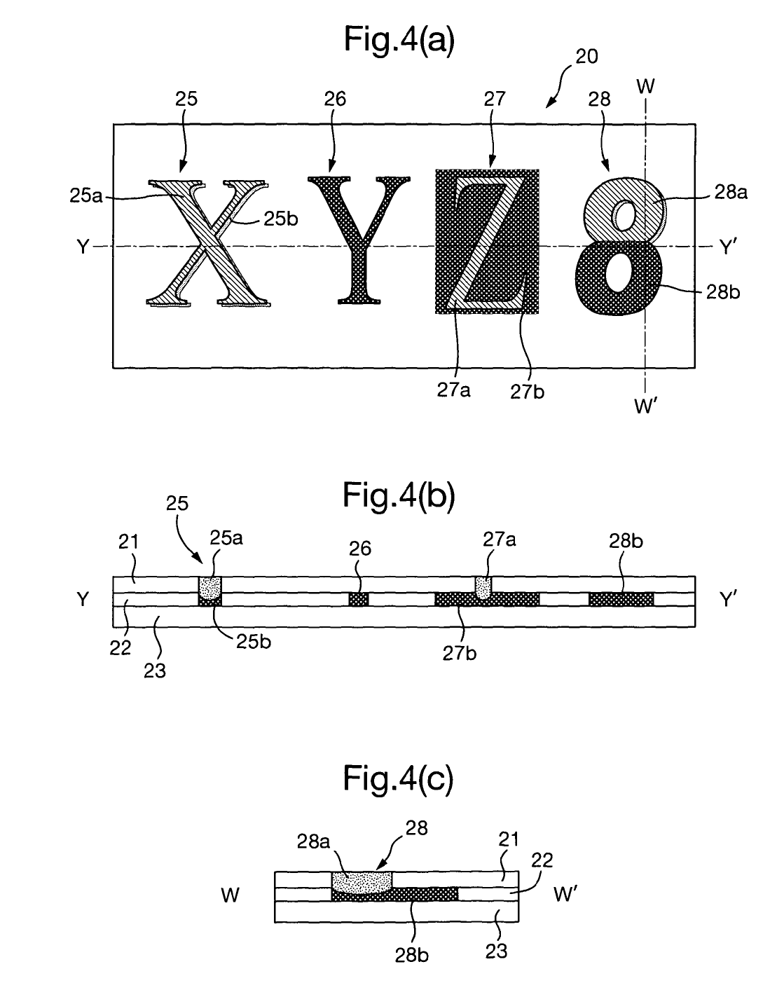

FIG. 4(a) shows a plan view of a third embodiment of a security article;

FIGS. 4(b) and 4(c) show two cross-sections through the security article of FIG. 4(a);

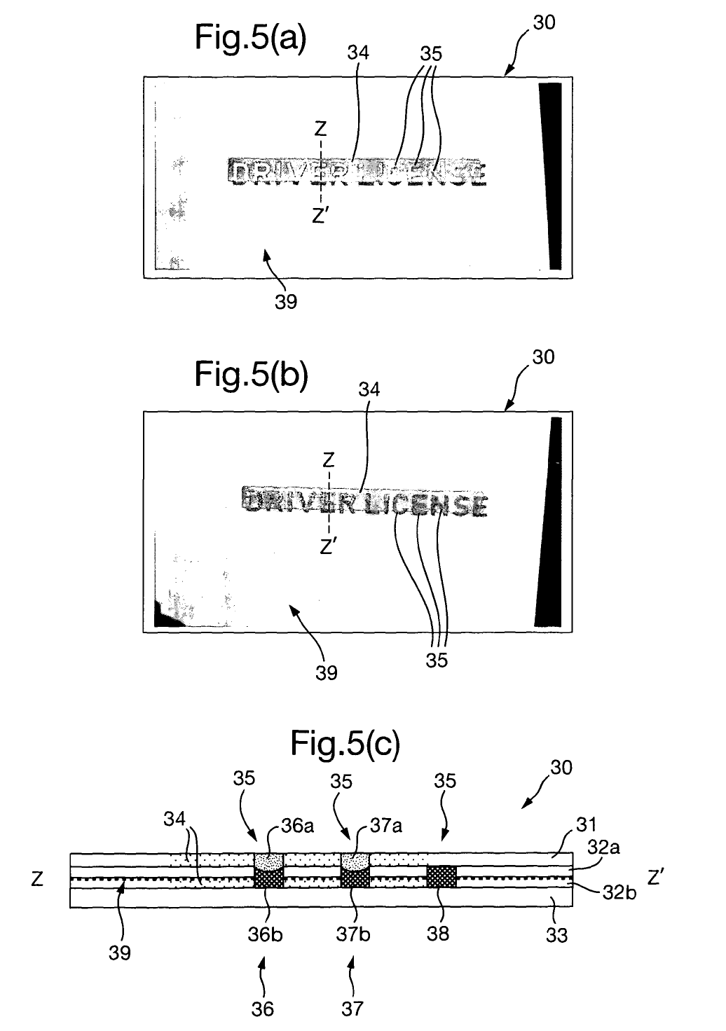

FIGS. 5 (a) and 5(b) show plan views of a fourth embodiment of a security article at different viewing angles; and

FIG. 5(c) shows a cross-section through the security article of FIGS. 5(a) and 5(b).

The description below will focus mainly on examples of security articles in the form of security documents such as ID cards, passports, licences, currency, credit cards and the like. However, as already noted, the disclosed security articles could take the form, for example, of security elements such as patches, threads, stripes or foils for application to objects including security documents.

FIGS. 1(a) and 1(b) illustrate a first embodiment of a security article 1 which is formed of a layer of plastics material 2, such as PET, polycarbonate, nylon, PVC, acrylic or the like (or any blend or combination thereof). The plastics material is preferably substantially visually transparent (i.e. clear, though may have a coloured tint) to the human observer. In this example, the layer 2 illustrated as self-supporting, for use as an ID card or similar but in other implementations it could take the form of a flexible film or similar, for application to a surface.

The security article 1 carries thereon an optically variable laser marking 5 having, in this example, a petal-like shape. The laser marking 5 comprises a portion of the plastics material 2 which has been modified upon irradiation by a laser. The portion 5 is optically variable in that its appearance varies depending on the viewing angle. For example, as illustrated in FIG. 1(b), when the laser marking 5 is viewed from a first position (i), it may appear bright, whereas when viewed from another angle such as position (ii), the same portion 5 appears dark. Thus, the portion 5 has a reflective quality (though not necessarily specularly reflective), appearing glossy and shiny at least some viewing angles. In particularly preferred implementations, the marking appears metallic, e.g. silver, its appearance changing from bright silver to dark grey as the article is tilted. Other metallic colours such as bronze or gold may be achieved if the plastics material 2 is tinted accordingly. The marking 5 may additionally be tactile, i.e. detectable by touch.

It will be noted from the above that no additional components or equipment are required to perceive the optically variable effect; it is apparent upon inspection of the laser marking alone (although this is not to say that the marking and its visual effect cannot be viewed through some other item or layer—for example, a coloured or uncoloured protective layer may be provided over the layer(s) containing the laser marking and the effect will still be visible therethrough). Further, the effect is exhibited by the portion 5 of the laser marking itself and not, for example, by some surrounding area of the article (although the surrounding area could be made to exhibit an additional optically variable effect if desired).

The provision of an optically variable laser marking such as this provides the article 1 with a high level of security, since not only is the laser marking 5 difficult or impossible to alter, it also cannot readily be reproduced using a photocopier, for example. A photocopy of the marking would appear optically invariable and thus could be easily distinguished from the original.

A preferred method of manufacturing the laser marking 5 involves a two-step laser irradiation process. In a first step, a first region 3 of the plastics material 2 is irradiated using a laser operating at low power (i.e. low beam intensity) and slow speed (i.e. long dwell time). In this example, the region 3 is circular. The plastics material 2 is largely transparent to the wavelength of the laser radiation and hence little or no visible modification of the material 2 occurs as a result of this step. However, due to the relatively long dwell time, a small fraction of the radiation is absorbed by the material, causing a slight darkening of the material which is typically not visible to the human eye (depending on the laser parameters and the particular characteristics of the material).

The plastics material 2 is then irradiated for a second time (using the same or another laser) across a second region 4 which at least partly overlaps the first region 3. In this example the region 4 is also circular. This second laser irradiation pass is carried out at a significantly higher power and faster speed (i.e. short dwell time) than the first laser pass. In areas of the second region 4 which do not coincide with the first region 3, the plastics material 2 will be largely unaffected by the irradiation and no visible marking will occur. However, in the portion of the second region 4 which overlaps the first region 3, the second laser pass is now absorbed by the material 2 to a significant degree, as a result of its pre-conditioning, leading to the optically variable laser marking 5 already described. It is believed that the combination of the two laser irradiation steps leads to a foam-like structure within the overlapping portion of the two regions which results in the optically variable effect.

It will be appreciated from the above that the outlines of the first and second regions 3 and 4 depicted in FIG. 1(a) are illustrated solely for explanation purposes and will generally not be visible in practice. Thus, in this example, the laser marking security feature consists solely of the optically variable portion 5. The marking can take any desirable shape, such as the geometric shape of the present example, though in many cases it is preferred that the marking takes the form of indicia such as alphanumeric or text, symbols, graphics and the like. Examples will be given below.

FIG. 2 is a flow diagram illustrating steps involved in a preferred method of manufacture of the security feature described above. In the first step

S100, a first region of the article is irradiated with a laser at a first laser power level P₁ and a first laser beam velocity V₁. In a second step, a second region of the security article which at least partially overlaps the first region is irradiated using a laser at a second laser power level P₂ and a second laser beam velocity V₂. Preferably, the same type of laser is used to perform both steps S100 and S200 (whether the exact same laser is used or a second laser of identical type), although this is not essential.

In a preferred example, an infrared Nd:YAG laser, such as the Trumpf™ VMC3 Nd:YAG laser, equipped with Trumark® software, operating at a wavelength of around 1064 nm is used, and the article to which the laser marking is applied comprises a sheet of PET of approximate thickness 50 microns. In the first laser irradiation step S100, the laser is operated at between 30% and 50% of its maximum power, preferably around 40%, and at a marking speed of approximately 2 to 3 square mm per second. For comparison, such power levels are significantly reduced compared to typical laser operation parameters in conventional laser marking processes, as is the beam velocity. In the second laser irradiation step S200, the laser is operated at a substantially higher power level, such as approximately 70 to 90% of its maximum power, preferably around 80%, and at a significantly faster marking speed, such as 18 to 20 square mm per second. These operating parameters in the second step are comparable to those of conventional laser marking processes and, if applied to a laser absorbent material (such as the adhesive layer containing laser absorbent additives described in our International Patent Application No. PCT/GB2009/001142), would produce a black marking. At portions of the two regions which overlap, an optically variable marking will be formed.

FIGS. 3(a) and 3(b) illustrate a second embodiment of a security article 10 which can be formed using the same technique. In this example, the security article 10 has a multi-layer structure in which the layer of plastics material 11 in which the optically variable laser marking is to be formed is supported by a substrate 13 and an adhesive layer 12 which mounts the plastics material 11 to the substrate 13. The plastics material 11 preferably forms the outermost layer of the article, although this is not essential. It should be noted that in this drawing, as in the other Figures, the thicknesses of the layers are exaggerated and not necessarily to scale with one another. The substrate 13 is preferably formed of a robust material such as Teslin™, paper or cardboard, which may be printed or unprinted. In this example, the upper surface of the substrate 13 is partially printed as illustrated by the shaded area 19. As in the previous example, the plastics material 11 may be formed for example, of PET, or other visually transparent plastic having a thickness in the region of 50 to 400 microns. The adhesive layer 12 is preferably also visually transparent in order that print 19 can be viewed therethrough.

The adhesive layer 12 in this example is a heat-sealable adhesive such as PE/EVA. Heat activated adhesives provide particular benefit since they may be extruded onto the substrate 13 (or otherwise applied in molten form), forming a strong bond upon setting. This is especially so in the case of a porous substrate 13 (such as Teslin™), since the adhesive permeates a distance into the substrate 13 before setting (not shown in the Figures for clarity). In general, the term “adhesives” is well-known and used in its usual sense here. For instance, an “adhesive” is a material which is tacky, or can be made to become tacky (e.g. by heating), so as to adhere to a surface or bond two surfaces together. Suitable adhesives include contact adhesives as well as heat activated adhesives. The underneath surface of the substrate 13 (opposite to that to which adhesive 12 is applied) may be left uncovered and unprinted (as depicted in FIG. 3(b)), or alternatively could be printed and/or covered by one or more layers of material such as a further layer of PET bonded to the underside of substrate 13 via a further adhesive layer, such that the construction of the article is largely symmetrical about substrate 13.

Like plastics layer 11, in this embodiment, the substrate 13 and adhesive 12 are largely transparent to the wavelength (s) of laser radiation to be employed. Two passes of the laser are performed, one at a low power level and low speed, and the other at relatively high power level and high speed, as previously discussed with respect to the first embodiment. In this example, the regions irradiated in each of the two steps are exactly coincident with one another, such that they entirely overlap. The resulting laser marking 15 is formed of three elements 15a, 15b and 15c depicting the digits 1, 2 and 3 respectively. Each digit has a optically variable appearance, typically appearing metallic silver. As indicated above, this is believed to result from a foam-like structure being formed in the plastics layer 11. As shown in the cross-section of FIG. 3(b), it has been found that the marking may extend some distance into the adjacent adhesive layer 12 beneath. Typically, the markings can also have a tactile quality, being detectable by touch at the surface of the article 10 as raised relative to the surrounding article.

A third embodiment of a security article 20 is depicted in FIGS. 4(a) and 4(b). In this example, the article 20 comprises, in addition to the plastics layer 21 in which the optically variable marking is to be formed, a second plastics layer 22 which is more highly absorbent to the laser irradiation than layer 21. This second layer 22 is located behind the first layer of the plastics material 21 (i.e. during marking, the layer 21 will be located between the laser source and the layer 22). In this example, the layer 22 comprises a layer of adhesive used to bond the plastics material 21 to a substrate 23 as described with respect to the second embodiment. However, in this case, the adhesive further includes a laser absorbent additive, such as a pigment which absorbs strongly at the wavelength to be employed. In the present example, the additive is a white pigment which undergoes a colour change to black upon irradiation by an infrared Nd:YAG laser operating at a wavelength of 1064 nm. A suitable additive is a calcined powder of co-precipitated tin and antimony as described in WO02/083567. Alternatives include the Micabs™ range of additives, supplied by Royal DSM N.V. The additive is preferably provided at a sufficient concentration that the layer 22 will be significantly marked by the laser operating at its high power, fast velocity parameters (unlike plastics layer 21). At these concentrations, the white pigment causes the adhesive layer 22 to become near opaque to the human eye. For example, an additive concentration in the range of around 1 to 10% (based on dry coat weight) has been found suitable for an adhesive layer thickness of around 50 to 80 microns. Higher additive layers and thicker adhesive layers yield improved laser marking results so, in this example, a preferred configuration has an adhesive layer thickness of around 75 microns with an additive concentration of between 5% and 10%.

As before, the underneath surface of the substrate 23 (which may comprise Teslin™ or similar) may be printed or unprinted, and can be sealed with cover layers as in the second embodiment, e.g. provided with layers of the same sort as layers 21 and 22 so that the same form of laser marking may be provided on both sides of the article.

The article 20 is then subjected to a two-step laser inscription process as described with respect to the first and second embodiments. In the first pass, the laser is operated at a low power setting and low marking speed to irradiate a first region consisting of “X”-shaped area 25, “Z”-shaped area 27, and area 28a forming the top section of the digit “8”. This causes slight modification of the plastics material 21 but little in the way of visible marking, whilst adhesive layer 22 will be lightly marked. In the second pass, the laser is operated at a higher power and higher speed to irradiate a second region consisting of X-shaped area 25, Y-shaped area 26, (solid) rectangular area 27b and “8”-shaped area 28. As depicted in FIG. 4(a) this results in a laser marking consisting of the letters X, Y and Z followed by the digit “8”, each letter/digit having different appearance characteristics.

In the area 25 forming the letter X, the first and second passes have been substantially coincident, leading to the formation of an optically variable laser marking 25a in the outer layer of plastics material 21 in the same manner as previously discussed. However, directly beneath this marking, the adhesive layer 22 is also marked by the high power, fast irradiation step as would be the case in conventional laser marking processes. Since the layer 22 is more highly absorbent to the laser radiation, it is significantly darkened by the second pass of the laser, typically turning dark grey or black. This appears as a shadow effect 25b, enhancing the appearance of the laser marking. When viewed from different angles, the amount of the dark marking 25b in the layer 22 which is visible behind the optically variable marking 25a varies, giving the letter X (in this example) a three-dimensional depth effect.

Typically, the dark marking 25b is prevalent at acute angles of viewing and less apparent when the article 20 is examined on axis. This leads to an optical “flipping” effect: when the marking is viewed at a highly acute angle, the underlying, dark marking 25b dominates the appearance of the marking and the letter “X” appears as if it were a conventional, black or dark grey, laser inscription. As the article is tilted towards a less acute angle of view, the optically variable marking 25b gradually obscures the underlying shadow, and the reflective nature of the marking 25b is appreciable. Thus, tilting the article between two angles causes the marking to appear to “switch” between a dark, conventional, non-metallic appearance, and the optically variable effect already described.

The letter Y is not formed at an overlapping portion of the two irradiation regions, but rather is formed solely during the second irradiation step at high power and high beam velocity. As such, the marking 26 is formed solely in the adhesive layer 22 and there is no optically variable effect. Rather, the letter Y will have the same dark grey or black appearance at all angles of view.

The next element of the laser marking is made up of an optically variable letter Z against an optically invariable background rectangle, collectively labelled 27. The region defining the letter Z itself forms part of the first region, irradiated at low power and low beam velocity. In the second irradiation step, a rectangular area encompassing and including the Z-shaped area is irradiated, resulting in an optically variable marking 27a forming the letter Z, and a dark grey or black marking 27b confined to the adhesive layer 22 surrounding it. This background region 27b is formed in the same manner as marking 26 (the letter

Y) and provides a uniform and visually unchanging area against which the appearance of the Z-shaped marking 27a can be compared as the article is viewed at different angles. Of course, the arrangement could be reversed such that the background 27b is optically variable whilst the letter Z is not, if preferred.

The final element of the laser marking is the digit “8”, labelled 28 and made up of two regions 28a and 28b. The upper section 28a of the digit is formed in the same manner as the letter “X” described above, i.e. it is irradiated in both the first and second laser passes. The lower section 28b of the digit is formed in the same manner as the letter “Y” described above, i.e. it is irradiated only during the second laser pass. The result is that the upper section 28a is optically variable, whereas the lower section 28b is not. The complete digit “8” is therefore made up of an optically variable region and an invariable region. FIG. 4(c) is a cross section along the line W-W′ in FIG. 4(a) which illustrates the different nature of the markings formed in sections 28a and 28b.

It will be appreciate that the security article need not comprise laser markings of all the different sorts illustrated by elements 25, 26, 27 and 28 in FIG. 4. For instance, the security article could carry any one of elements 25, 27 or 28 alone or in combination with other features.

A fourth embodiment of the security article which can be made using the above-described technique is depicted in FIGS. 5(a), 5(b) and 5(c). Here,

FIGS. 5(a) and 5(b) are photographs showing the laser marking at two different viewing angles. It will be apparent that here the marking takes the form of the words “DRIVER LICENSE” formed of letters 35, against a rectangular background area 34. The background area 34 is slightly offset from the letters 35 such that the lowermost extremity of each letter does not overlap the background. In FIG. 5(a), when the article 30 is viewed at a first angle, the optically variable letters 35 appear bright relative to the background 34 except for those parts of the letters which do not overlap the background and appear dark. When the article is viewed at a second angle, as depicted in FIG. 5(b), the letters 35 appear dark relative to the background 34 across their full extent.

FIG. 5(c) shows a cross-section along the line Z-Z′ through one of the letters “E”. In this example, the article 30 has a multi-laminate construction which can be formed as disclosed in any of the embodiments of our International patent application PCT/GB2009/001142. The plastics material 31, comprising PET or similar, is mounted to a substrate 33 via multiple layers of adhesive 32. In this example, two adhesive layers are provided: an outer adhesive layer 32a which is substantially transparent to the laser radiation (akin to adhesive layer 12 of FIG. 3(b)), and an inner adhesive layer 32b which contains a laser absorbent additive as described with respect to FIG. 4(b), although additional adhesive layers could be included if desired. In preferred examples, a print layer 39 is disposed between the two adhesive layers 32a and 32b using the techniques disclosed in PCT/GB2009/001142. Typically, this print layer 39 will be used to provide features such as security prints and background prints which may be the same for a series of security articles, whilst the laser marking presently disclosed may be used to additionally apply personalisation information to the article, such as the holder's name, photograph or other bibliographic data.

Again, the laser marking is preferably produced in a two-step laser radiation process as described in the previous embodiments. In a first step, rectangular region 34 is irradiated at a low power and low marking speed to produce the uniform background. For instance, in one example the time taken to mark a rectangular region 34 of approximate dimensions 40 mm×4 mm (=160 square mm) is approximately 60 seconds, which corresponds to a marking speed of around 2.66 square mm per second, during which the laser may be operated at around 40% of its maximum power. This causes slight modification of the outer plastics layer 31 (which may or may not itself be visually noticeable) together with a more apparent darkening of the inner adhesive layer 32b. As a result of the low laser power level and absorption by the outer plastics layer 31, the modification of the inner adhesive layer 32b is not as substantial as occurs during conventional laser marking (or the second laser pass) and, hence, the resulting marking has a mid-grey, uniform appearance.

In the second laser pass, the laser beam is controlled to irradiate regions forming the letters 35 reading “DRIVER LICENSE”. The second laser pass takes place at a higher power (e.g. 80%) and faster marking speed—for instance, in this example, the total area occupied by the letters “DRIVER LICENCE” is around 110 square mm, and is marked in around 6 seconds, which corresponds to a marking speed of around 18.3 square mm per second. Three of the areas forming the letters are identified as items 35 in FIG. 5(c). Where the second irradiated region overlaps with the background 34, optically variable marking 36a and 37a are formed in the plastics layer 31 and underlying shadow markings 36b and 37b are formed in the adhesive layer 32b, directly beneath.

The dark marking 36b, 37b tend to extend some way into the adjacent adhesive layer 32a due to local heating of the material. The portions of the letters 35 overlying the background 34 thus have an optically variable, three-dimensional appearance as previously described with respect to marking 25 in FIG. 4. In FIG. 5(c), marking 36 corresponds to the uppermost horizontal bar of the letter “E” thorough which the cross-section was taken, and marking 37 corresponds to the middle horizontal. The lowermost horizontal, marking 38, does not overlap the background 34. As such, as shown in FIG. 5(c), marking 38 consists solely of a dark, optically invariable marking formed in the adhesive layer 32b. There is no modification of the outermost plastics layer 31 and hence no optically variable effect.

The adhesive layers 32a and 32b are preferably formed of the same adhesive material although this need not be the case provided the two layers are compatible with one anther, forming a strong bond. The adhesive used is preferably a heat sealing adhesive which, when heated, melts or flows, thus forming a strong bond between the two adjacent adhesive layers. Where similar adhesives are used for layers 32a and 32b, on bonding, they effectively merge into one another forming a single continuous adhesive layer. Bonding can be achieved by using a standard lamination process in which temperatures typically reach around 110° C. After lamination, the layers cannot be separated without destroying the print layer 39 that is held within the adhesive. Typically, the print layer 39 comprises graphics, text or symbols which are to be common to all, or at least a number of, the articles so produced. For example, the print 39 could take the form of a background pattern for enhancing the appearance of the document. The print 39 could include security features such as fine line designs and could be applied using coloured or security inks, such as UV or IR responsive inks, to increase difficulty of forgery.

The laser marking is preferably configured to convey data, such as personalisation information and can be machine-readable, e.g. including a barcode or machine-recognisable text. However, in other examples, the laser marking could take the form of graphics, e.g. pictures, patterns or images. Where printed data is additionally provided, as in the second and fourth embodiments, the printed and laser-inscribed data may in some cases overlap one another whereas in other examples they may be laterally spaced apart.

It will be appreciated that any of the above described embodiments could be combined with one another. For instance, the underneath surface of the substrate 13 forming part of the second embodiment could be provided with layers 21 and 22 of the third embodiment or layers 31, 32a and 32b of the fourth embodiment, so as to achieve different laser marking effects on each side of the article. This is particularly appropriate where the article itself forms a security document. Alternatively, any of the embodiments could be provided with additional layers to enable their use as transfer elements for application to other objects. For example, any of the embodiments could be provided with an additional adhesive layer on the underside of the substrate for bonding the article to an object.

In further examples, the article of the current invention can be made machine-readable by the introduction of detectable materials in any of the layers previously described (particularly one or more of the adhesive layers) or by the introduction of separate machine-readable layers. Detectable materials that react to an external stimulus include but are not limited to: fluorescent, phosphorescent, infrared absorbing, thermochromic, photochromic, magnetic, electrochromic, conductive and piezochromic materials. Furthermore, the security article could also comprise an antenna and integrated circuit chip utilising the laminate structure disclosed in PCT/GB2009/001142, for example, and/or could also comprise a hologram applied to one of the adhesive layers. Structures incorporating holograms are also disclosed in PCT/GB2009/001142.

1-42. (canceled)

43. A method of manufacturing a security feature on a security article, the security article comprising a first layer of plastics material, the method comprising, in the following order:
using a laser to irradiate a first region of the first layer of plastics material, the laser being operated at a low power level and low speed; and
using a laser to irradiate a second region of the first layer of plastics material, the second region at least partially overlapping the first, the laser being operated at a higher power level and higher speed relative to the irradiation of the first region;
whereby the overlapping portions of the regions are marked and exhibit an optically variable appearance.

44. A method according to claim 43 wherein the higher power level is between 1.5 and 4 times higher than the low power level.

45. A method according to claim 43 wherein the higher speed is between 2 and 20 times higher than the low speed.

46. A method according to claim 43 wherein the optically variable marked overlapping portions have a reflective appearance, appearing bright at some viewing angles and relatively dark at others.

47. A method according to claim 43 wherein the optically variable marked overlapping portions have a metallic appearance.

48. A method according to claim 43 wherein any non-overlapping portions of the first region and/or any non-overlapping portions of the second region are additionally marked and display an optically invariable appearance.

49. A method according to claim 43 wherein the first layer of plastics material is substantially visually transparent.

50. A method according to claim 43 wherein the first layer of plastics material is sufficiently transparent to the laser radiation such that irradiation at the higher power and higher speed will not substantially mark the plastics material.

51. A method according to claim 43 wherein the security article further comprises a second layer of plastics material arranged behind the first and being more highly absorbent to the laser radiation, whereby in the overlapping portions, the second layer of plastics material becomes darkened and exhibits a shadow effect behind the optically variable appearance visible at at least some angles of viewing.

52. A method according to claim 51 wherein the second layer of plastics material is sufficiently absorbent to the laser radiation that it will be blackened by irradiation by the laser at the higher laser power and higher speed.

53. A method according to claim 51 wherein, at an acute viewing angle, the darkened portions of the second layer of plastics material dominate the appearance of the security feature, causing it to appear dark and optically invariable, and at less acute viewing angles, the optically variable appearance of the security feature is visible.

54. A method according to claim 43 wherein the security article further comprises a substrate and at least one adhesive layer arranged between the substrate and the first layer of plastics material.

55. A method according to claim 54 wherein at least one of the at least one adhesive layers contains a laser-absorbent additive and constitutes a second layer of plastics material arranged behind the first and being more highly absorbent to the laser radiation, whereby in the overlapping portions, the second layer of plastics material becomes darkened and exhibits a shadow effect behind the optically variable appearance visible at at least some angles of viewing.

56. A security article comprising a first layer of plastics material exhibiting a laser marking of which at least a portion has an optically variable appearance, wherein the laser marking is formed in accordance with the method of claim 43.

57. A security article comprising a first layer of plastics material having therewithin a laser marking comprising internally laser-modified plastics material of which at least a portion has an optically variable appearance, wherein the optically variable portion of the laser marking has a reflective appearance, appearing bright at some viewing angles and relatively dark at others.

58. A security article according to claim 57 wherein the optically variable portion of the laser marking has a metallic appearance.

59. A security article according to claim 57 wherein the laser marking further comprises at least one optically invariable region.

60. A security article according to claim 57 wherein the first layer of plastics material is substantially visually transparent.

61. A security article according to claim 57 further comprising a second layer of plastics material arranged behind the first and being more highly absorbent to laser radiation, whereby behind the optically variable portions of the laser marking, the second layer of plastics material appears dark and exhibits a shadow effect visible at at least some angles of viewing.

62. A security article according to claim 61 wherein, at an acute viewing angle, the darkened portions of the second layer of plastics material dominate the appearance of the security feature, causing it to appear dark and optically invariable, and at less acute viewing angles, the optically variable appearance of the security feature is visible.

63. A security article according to claim 57 further comprising a substrate and at least one adhesive layer arranged between the substrate and the first layer of plastics material.

64. A security article according to claim 63 wherein at least one of the at least one adhesive layers contains a laser-absorbent additive and constitutes a second layer of plastics material arranged behind the first and being more highly absorbent to laser radiation, whereby behind the optically variable portions of the laser marking, the second layer of plastics material appears dark and exhibits a shadow effect visible at at least some angles of viewing.

65. A security article according to claim 57 wherein the laser marking is formed by a method comprising:
using a laser to irradiate a first region of the first layer of plastics material, the laser being operated at a low power level and low speed; and
using a laser to irradiate a second region of the first layer of plastics material, the second region at least partially overlapping the first, the laser being operated at a higher power level and higher speed relative to the irradiation of the first region;
whereby the overlapping portions of the regions are marked and exhibit an optically variable appearance.

66. A security article according to claim 56 wherein the security article is one of: a security document or a security element.

67. A security article according to claim 57 wherein the security article is one of: a security document or a security element.
